(19) United States
(12) Patent Application Publication
(10) Pub. No.: US 2012/0135655 A1
(43) Pub. Date: May 31, 2012

(54) THERMOPLASTIC COMPOSITE FOR STIFFENER AND METHOD FOR PREPARING SAME

(75) Inventor: Min Ho Choi, Gwangmyeong (KR)

(73) Assignee: HYUNDAI MOTOR COMPANY, Seoul (KR)

(21) Appl. No.: 13/087,754

(22) Filed: Apr. 15, 2011

(30) Foreign Application Priority Data
Nov. 29, 2010 (KR) 10-2010-00120081

(51) Int. Cl. B32B 27/04; B32B 5/16; B05D 3/02; B82Y 30/00

(52) U.S. Cl. 442/179; 427/372.2; 442/59; 442/180; 977/742

(57) ABSTRACT

Provided are a thermoplastic composite for an impact modifier and a method for preparing the same. More particularly, the thermoplastic composite includes a polycarbonate resin including carbon nanotube and cyclic butylene terephthalate impregnated into a fiber mat. The thermoplastic composite is prepared by uniformly coating a polycarbonate resin including carbon nanotube and cyclic butylene terephthalate on a fiber mat and heating to melt the resin, so that the melt resin is impregnated into the fiber mat. With superior mechanical strength, conductivity, electromagnetic shielding property and coating property, the disclosed thermoplastic composite may replace the currently used steel-based impact modifiers such as bumper back beams, front-end module carriers, door side impact bars, or the like.

### CROSS-REFERENCE TO RELATED APPLICATIONS

This application claims priority under 35 U.S.C. §119 to Korean Patent Application No. 10-2010-0120081, filed on Nov. 29, 2010, in the Korean Intellectual Property Office, the disclosure of which is incorporated herein by reference in its entirety.

### BACKGROUND

(a) Technical Field

The present invention relates to an impact modifier, particularly a thermoplastic composite, designed to absorb external impact, and in particular impact upon rear-end or head-on collision of a vehicle, and a method for preparing the same. Materials of the present invention are capable of replacing steel-based impact modifiers used in bumper back beams, front-end module carriers and side impact bars, thereby reducing the weight of the vehicle.

(b) Background Art

In the auto industry, significant research is focused on the production of eco-friendly vehicles having high fuel efficiency and emitting less carbon dioxide. In particular, research is being carried out in the development of eco-friendly vehicles that utilize alternative energy sources, including electric cars, hybrid vehicles, hydrogen vehicles, solar vehicles, and so forth. However, much time and cost will be required to replace existing vehicles having internal combustion engines. Thus, in the short run, automakers are trying to reduce the vehicle weight by using lightweight materials in order to improve fuel efficiency and reduce carbon dioxide emission.

Of the chassis parts of a vehicle, impact modifiers such as a bumper back beam, a front-end module carrier and a door side impact bar are made of materials or with structures capable of absorbing impact upon collision, particularly rear-end or head-on collision, in order to protect passengers and minimize damage to the vehicle. Although the impact modifiers are made mostly of steel sheets, the development of suitable plastic parts is actively being carried out for the purpose of weight reduction.

Since plastic lacks conductivity or electromagnetic shielding property, it is prepared into a plastic composite by mixing with a large amount of carbon black, conductive polymers, carbon fiber, etc. or plating or coating with copper, silver, etc. in order to confer conductivity or electromagnetic shielding property. However, the conductive polymers have poor solubility in organic solvents and have poor heat resistance. Carbon black, carbon fiber and metal particles are disadvantageous over carbon nanotube because of their low dispersibility and high weight in polymers. In contrast, carbon nanotube significantly improves electromagnetic shielding property even if added at small amounts, and further improves thermal, mechanical and electrical properties.

In the auto industry, it is not uncommon to build parts as modules in order make assembly easier. That is to say, although all the vehicle parts may have been assembled in the vehicle assemblage line, some parts are pre-assembled as modules to save time and cost. Examples of such modules include door module, headlining module, cockpit module and front-end module.

The front-end module, which is a module of vehicle front-end parts, is equipped at the front end of a vehicle. It includes of the radiator, fan shroud, cooling fan, headlights, etc. Recently, the bumper back beam has also been included. These parts are integrally mounted to the front-end module carrier. In general, the front-end module carrier is either a plastic type made of plastic only or a hybrid type injection-molded after inserting a steel sheet. Although the plastic-type front-end module carrier is light and easily processable, it is weak against collision due to insufficient stiffness and durability. The hybrid-type front-end module carrier has better stiffness and durability than the plastic-type front-end module carrier, but it is heavier. Thus, the plastic-type front-end module is generally adopted for compact cars, while the hybrid-type front-end module is generally adopted for mid-to-large-sized vehicles.

### SUMMARY

The present invention decreases the weight of vehicle parts, reduces carbon dioxide emission and improves fuel efficiency by replacing the steel sheets conventionally used for impact modifiers, such as bumper back beam, front-end module carrier, and door side impact bar, with thermoplastic composites. The present invention provides a thermoplastic composite that overcomes the stiffness insufficiency of existing plastic parts for impact modifiers, is mass-producible by thermoforming, possesses superior mechanical strength, and further has such functionality as electromagnetic shielding.

In one general aspect, the present invention provides a thermoplastic composite comprising a polycarbonate resin including suitable amounts of carbon nanotube and cyclic butylene terephthalate impregnated into a fiber mat. According to certain embodiments, the thermoplastic composite comprises about 0.5-6% by weight of carbon nanotube and about 1-5% by weight of cyclic butylene terephthalate, wherein weight % are relative to the total weight of the thermoplastic resin.

In another general aspect, the present invention provides a method for preparing a thermoplastic composite comprising: coating a polycarbonate resin uniformly on a fiber mat; and heating the fiber mat with the resin coated to 250-290° C. to melt the resin, so that the melt resin is impregnated into the fiber mat. The polycarbonate includes suitable amounts of carbon nanotube and cyclic butylene terephthalate, and in various aspects, includes about 0.5-6% by weight of carbon nanotube and 1-5% by weight of cyclic butylene terephthalate.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

The above and other aspects and features of the present invention will be described infra.

### BRIEF DESCRIPTION OF THE DRAWING

The above and other objects, features and advantages of the present disclosure will now be described in detail with reference to certain exemplary embodiments thereof illustrated in the accompanying drawing which is given hereinbelow by way of illustration only, and thus is not limitative of the disclosure, and wherein:

FIG. 1 schematically shows a vehicle front-end module.

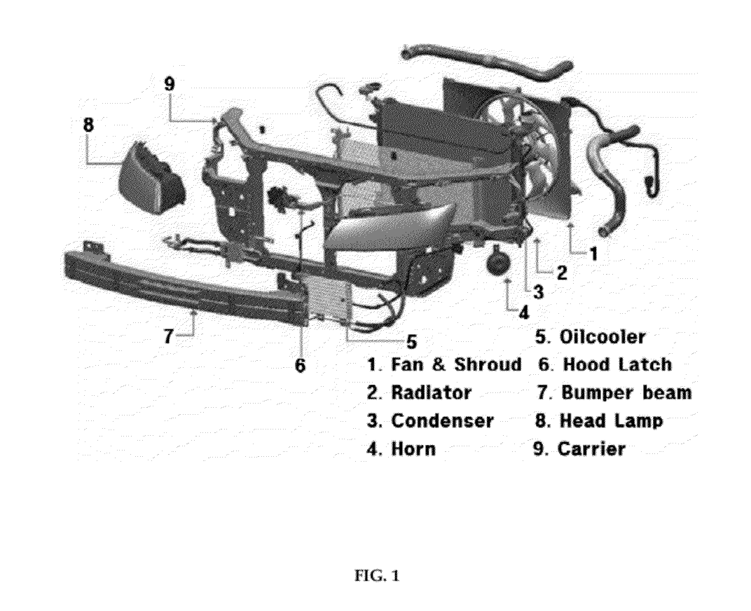

It should be understood that the appended drawing is not necessarily to scale, presenting a somewhat simplified representation of various preferred features illustrative of the basic principles of the disclosure. The specific design features of the disclosure as disclosed herein, including, for example, specific dimensions, orientations, locations and shapes, will be determined in part by the particular intended application and use environment.

### DETAILED DESCRIPTION

Hereinafter, reference will now be made in detail to various embodiments of the present disclosure, examples of which are illustrated in the accompanying drawings and described below. While the disclosure will be described in conjunction with exemplary embodiments, it will be understood that the present description is not intended to limit the disclosure to those exemplary embodiments. On the contrary, the disclosure is intended to cover not only the exemplary embodiments, but also various alternatives, modifications, equivalents and other embodiments, which may be included within the spirit and scope of the disclosure as defined by the appended claims.

The present disclosure relates to a thermoplastic composite prepared by impregnating a polycarbonate resin into a fiber mat, wherein the polycarbonate resin preferably further comprises carbon nanotube and cyclic butylene terephthalate. The thus formed composite provides improved mechanical strength, conductivity, electromagnetic shielding property and coating property that is not attainable with the existing plastic materials.

According to some embodiments, the fiber mat may be a glass fiber mat or a carbon fiber mat for further improving mechanical strength and impact resistance. Since fibers are generally aligned along a predetermined direction in the fiber mat, it may exhibit superior mechanical properties along a specific direction. Further, when the fiber mat is formed into multiple layers such as weave, biax, etc., optimized properties may be attained depending on parts.

In the present invention, a resin having a very low melt viscosity is preferably used so that the resin may uniformly penetrate and be easily impregnated into the glass fibers or carbon fibers comprising the mat. In general, polymer resins having superior thermal and mechanical strength, such as heat resistance and impact strength, are viscoelastic and tend to have a very high melt viscosity. As a result, they are not easily impregnated into the fiber mat, and it is difficult to make them into high-strength composites with high fiber contents. To address this problem, sheet molding compounds (SMC), bulk molding compounds (BMC), or the like have been developed. However, since these materials are thermosets, not thermoplastics, they require a lot of time and cost for fabrication and are not easily recycled. Further, since the polymer resin is generally not fully impregnated between the fibers of the fiber mat, fatigue failure or other durability problems may occur at the portion(s) where the polymer resin is not filled.

In the present invention, a resin material is used that can easily penetrate into fibers is impregnated well and, thus, is capable of improving physical properties. In particular, according to embodiments of the invention, a material comprising an engineering plastic polycarbonate resin and cyclic butylene terephthalate (hereinafter, ‘CBT’) is used. Polycarbonate is widely used as an engineering plastic because it has high heat resistance and impact strength. However, it is restricted in use as a matrix resin for a composite material because it has high melt viscosity. In accordance with the present invention, the polycarbonate is blended with CBT in order to significantly reduce melt viscosity, thus improving processability while maintaining the properties of the polycarbonate resin (e.g. as described in Korean Patent Registration No. 10-0808285). Oligomeric CBT has a melting temperature of 135° C. or above, unlike single molecular CBT, and thus it does not melt out at room temperature after being blended with the polycarbonate resin. The CBT may be blended with the polycarbonate resin in any suitable amount that provides the desired reduction of melt viscosity and improvement in processability, and according to a preferred embodiment, the CBT is blended with the polycarbonate resin in an amount of about 1-5% by weight, wherein the wt % is based on total weight of the polycarbonate resin, plus the CBT, plus the carbon nanotube. If the content of the CBT is too low, the melt viscosity of the polycarbonate resin may not be decreased enough. On the other hand, it the content of CMT is too high, e.g. exceeding 5% by weight, mechanical properties may be unsatisfactory. Melt flow index of the polycarbonate resin as a function of the CBT content is given in Table 1.

TABLE 1

| CBT content (% by weight) | Melt flow index (300° C., 1.2 kg) |
|---|---|
| 0 | 17 |
| 1 | 19 |
| 3 | 26 |
| 5 | 30 |

According to the present invention, addition of the carbon nanotube serves to strengthen the mechanical properties of the composite, confer electromagnetic shielding property and conductivity to the composite, and improve coating property. The carbon nanotube may be included in the polycarbonate resin in any suitable amount that provides these properties as desired, and in a preferred embodiment, is included in an amount of about 0.5-6% by weight based on total weight of the polycarbonate resin, plus the CBT, plus the carbon nanotube. If the content is too low, e.g. below 0.5% by weight, a desired effect may not be exerted. If the amount of carbon nanotube exceeds 6% by weight, a better effect will generally not be attained but will result in increased cost.

According to some embodiments, a small amount of a UV stabilizer and/or an additive for color control and/or other suitable additives may be further added to the polycarbonate resin if desired.

The polycarbonate resin including the carbon nanotube and the CBT may be impregnated into the fiber mat to obtain a thermoplastic composite. The amount of the fiber mat in the composite may be any suitable amount such as, for example, about 45-55% by volume. If the amount is too low, such as less than 45% by volume, deformation may occur due to insufficient stiffness. And, if it is too high and exceeds, for example, 55% by volume, thermoforming may not be carried out easily due to excessive stiffness.

The present disclosure also relates to a method for preparing the thermoplastic composite.

In particular, according to a method of the present invention, a fiber mat with a desired shape, thickness and structure, based on the end use of the composite, is first prepared. Then, a polycarbonate resin comprising carbon nanotube and CBT is uniformly coated on the fiber mat. As described earlier, the polycarbonate resin is provided with suitable amounts of carbon nanotube and CBT, for example, the contents of the carbon nanotube and the CBT may be 0.5-6% and 1-5% by weight, respectively. The coating amount of the resin on the fiber mat is controlled such that the amount of the fiber mat is suitable, preferably 45-55% by volume based of the volume of the thermoplastic composite.

The resin coated on the fiber mat is then melted and impregnated into the fiber mat by heating. The heating temperature may be suitably selected based on the composition of the coated resin, and generally is between 260-290° C. If the temperature is too low, e.g. below 260° C., the resin may not be melted but will remain as solid particles, resulting in unsatisfactory physical properties. On the other hand, if the temperature is too high, e.g. exceeds 290° C., physical properties may be unsatisfactory due to degradation of the resin.

Through the above process, a thermoplastic composite in the form of a pre-preg (pre-impregnated composite) is prepared. The pre-preg is in a solidified state wherein the melted resin is sufficiently impregnated into the fiber mat. The thermoplastic composite pre-preg may be prepared into a part with a desired shape via a thermoforming process. More specifically, the pre-preg is heated, inserted in a mold with a desired shape, and then compressed to prepare the part. This thermoforming process is not applicable to a thermoset plastic composite, since the thermoset plastic does not become ductile by heating once it is melted and then solidified. Thus, in accordance with the present invention, a thermoplastic material is preferably used to avoid this problem and enable mass production.

### EXAMPLES

The examples and experiments will now be described. The following examples and experiments are for illustrative purposes only and not intended to limit the scope of this disclosure.

### Examples 1-6 and Comparative Examples 1-3

For fabrication of a front-end module carrier, a functional fiber mat was prepared. A glass fiber mat was selected. The mat was laminated into 4 layers to maximize stiffness with a structure of weave (0/90°)+biax (+45/−45°)+biax (+45/−45°)+weave (0/90°).

Then, a polycarbonate resin (LG Dow) comprising carbon nanotube and CBT (Cyclics) was uniformly coated on the fiber mat and impregnated by heating at 280° C. for 10 minutes.

As a result, a thermoplastic composite was obtained in the form of a pre-preg. The pre-preg was 1.3 mm thick. The composite was preheated at 270° C., inserted in a thermoforming mold and compressed with a pressure of 5-10 atm to fabricate a front-end module carrier. It is noted that if the pressure is below 5 atm, delamination of the mat may occur due to insufficient bonding between the mats. On the other hand, if it exceeds 10 atm, the fiber structure may be broken.

The contents of the carbon nanotube (CNT) and the CBT included in the polycarbonate and the amount of the fiber mat on the basis of the thermoplastic composite are given in Table 2.

TABLE 2

| | | | Fiber mat |
|---|---|---|---|
| | CNT (% by weight) | CBT (% by weight) | (% by volume) |
| Example 1 | 4 | 1 | 50 |
| Example 2 | 4 | 3 | 50 |
| Example 3 | 4 | 5 | 50 |
| Example 4 | 0.5 | 3 | 55 |
| Example 5 | 1 | 3 | 55 |
| Example 6 | 2 | 3 | 55 |
| Comparative | 4 | 3 | 30 |
| Example 1 | | | |
| Comparative | 4 | 3 | 40 |
| Example 2 | | | |
| Comparative | 4 | 3 | 60 |
| Example 3 | | | |

Physical Properties

Tensile properties of the thermoplastic composites prepared in Examples 1-6 and Comparative Examples 1-3 were tested according to ASTM D3039.

TABLE 3

| | Tensile strength (MPa) | Tensile modulus (GPa) |
|---|---|---|
| Example 1 | 425 | 19 |
| Example 2 | 428 | 20 |
| Example 3 | 415 | 17 |

Table 3 compares tensile strength and tensile modulus of the composites as a function of the CBT content. It can be seen that the physical properties do not change significantly with the CBT content. But, as the CBT content increases, the mechanical strength decreased slightly because the relative content of polycarbonate decreased.

TABLE 4

| | Tensile strength (MPa) | Surface resistance (Ω/m²) |
|---|---|---|
| Example 4 | 425 | 4 × 10¹² |
| Example 5 | 430 | 3 × 10¹⁰ |
| Example 6 | 430 | 2.5 × 10⁸ |

Table 4 compares tensile strength and surface resistance of the composites as a function of the CNT content. It can be seen that the tensile strength does not change significantly with the CNT content but the surface resistance decreases greatly as the CNT content increases. All of Examples 4-6 showed satisfactory conductivity, with the surface resistance less than 5×10¹² Ω/m².

TABLE 5

| | Tensile strength | Tensile modulus |
|---|---|---|
| | (MPa) | (GPa) |
| Comparative Example 1 | 168 | 13.8 |
| Comparative Example 2 | 267 | 16.3 |
| Example 2 | 428 | 20 |
| Comparative Example 3 | 485 | 23 |

Table 5 compares tensile strength and tensile modulus of the composites as a function of the fiber mat content in the composite. Comparative Examples 1-2 with low fiber mat contents showed too poor tensile strength and tensile modulus to be used for the front-end module carrier of a vehicle. Comparative Example 3 with a high fiber mat content exhibited good physical properties, but the product appearance was not good because of difficulty in thermoforming. Surface resistance was about 1×10⁵ Ω/m² for all of Example 2 and Comparative Examples 1-3.

The mechanical properties of the thermoplastic composite prepared in Example 2 were compared with those of other materials (see Table 6). Here, the specific strength is a material's strength divided by its density.

TABLE 6

| | Specific | Tensile | |
|---|---|---|---|
| | strength | strength | Density |
| | (s/ρ: MPa) | (MPa) | (g/cm³) |
| Example 2 | 238 | 428 | 1.8 |
| Nylon | 69 | 78 | 1.13 |
| Polypropylene | 37 | 33 | 0.9 |
| Glass fiber-reinforced (35 wt %) nylon | 120 | 192 | 1.6 |
| Iron | 42 | 346 | 8.3 |
| Aluminum | 115 | 312 | 2.7 |

As seen from Table 6, the thermoplastic composite according to the present disclosure has much higher specific strength than iron or aluminum, which is currently used as an impact modifier. That is to say, it exhibits superior strength while being lighter. Thus, when used for a bumper back beam, a front-end module carrier, a door side impact bar, or the like, it will contribute to weight reduction of a vehicle and improvement in fuel efficiency.

With superior mechanical strength, conductivity, electromagnetic shielding property and coating property, the thermoplastic composite according to the present invention may be usefully employed in impact modifiers such as bumper back beams, front-end module carriers, door side impact bars, or the like. Since the impact modifier is about 30% lighter than the existing steel-based impact modifier, it will contribute to weight reduction of a vehicle and improvement in fuel efficiency.

The present disclosure has been described in detail with reference to specific embodiments thereof. However, it will be appreciated by those skilled in the art that various changes and modifications may be made in these embodiments without departing from the principles and spirit of the disclosure, the scope of which is defined in the appended claims and their equivalents.

What is claimed is:

1. A thermoplastic composite comprising:
a polycarbonate resin comprising about 0.5-6% by weight of carbon nanotube and about 1-5% by weight of cyclic butylene terephthalate impregnated into a fiber mat.

2. The thermoplastic composite according to claim 1, wherein the fiber mat is a glass fiber mat or a carbon fiber mat.

3. The thermoplastic composite according to claim 1, wherein the composite comprises the fiber mat in an amount of about 45-55% by volume.

4. A method for preparing a thermoplastic composite comprising:
coating a polycarbonate resin comprising about 0.5-6% by weight of carbon nanotube and about 1-5% by weight of cyclic butylene terephthalate uniformly on a fiber mat; and
heating the coated fiber mat about to 250-290° C. to melt the resin, such that the melt resin is impregnated into the fiber mat.

5. An impact modifier prepared using a thermoplastic composite, the thermoplastic composite comprising:
a polycarbonate resin comprising about 0.5-6% by weight of carbon nanotube and about 1-5% by weight of cyclic butylene terephthalate impregnated into a fiber mat.

6. The impact modifier according to claim 5, wherein the fiber mat is a glass fiber mat or a carbon fiber mat.

7. The impact modifier according to claim 5, wherein the thermoplastic composite comprises the fiber mat in an amount of about 45-55% by volume.
